(19) United States
(12) Patent Application Publication
(10) Pub. No.: US 2012/0177456 A1
(43) Pub. Date: Jul. 12, 2012

(54) METHOD FOR MACHINING A DENTAL PROSTHESIS

(76) Inventors: Yunoh Jung, Murray, UT (US); Daniel Yonil Jung, Murray, UT (US)

(21) Appl. No.: 12/987,733

(22) Filed: Jan. 10, 2011

(51) Int. Cl. B23B 35/00; B32B 3/06; B23B 51/00

(52) U.S. Cl. 408/1 R; 408/146; 428/99

(57) ABSTRACT

A method for machining a dental prosthesis that reduces the likelihood of forming tool failure includes machining a workpiece to form a bottom surface without machining a bottom cavity of the dental prosthesis, then machining the bottom cavity and machining the top.

### RELATED APPLICATION(S)

This is related to application Ser. No. 12/963,856, filed Dec. 9, 2010, which is herein incorporated by reference in its entirety.

### BACKGROUND

1. Field of the Invention

The present invention relates generally to manufacturing a dental prosthesis. More particularly, the present invention relates to machining a dental prosthesis.

2. Related Art

Various different methods have been developed for manufacturing dental prostheses. One type of manufacturing process used to manufacture dental prostheses is machining. A machining process may form a part by removing material. A forming tool may be used to remove material. Typical forming tools may remove material by cutting or abrading. For example, an end mill is a typical “cutter” and a grinder is typical of an abrading tool. A machine tool rotates the forming tool, typically at a high speed, so that the forming tool can remove material from a workpiece. A typical workpiece may begin as a solid block of material. Successive passes with the forming tool may be necessary to remove enough material from the workpiece to achieve a final part.

In machining a dental prosthesis, the relatively small scale typically requires using forming tools that are small enough to allow accurate machining of the dental prosthesis features. The drawback is that a small tool is not as strong as a larger tool of the same quality. Materials used for dental prostheses typically have a high hardness in order to meet the strength and longevity demands placed upon them in service. Harder materials are more difficult to machine than materials of lesser hardness. Moreover, a bottom side of a dental prosthesis may have a relatively deep concave surface that serves as an interface with a post or tooth and where the dental prosthesis is cemented or bonded to the post or tooth. The depth of the material to be removed from this bottom surface may increase the force on the forming tool while machining this region. The smaller forming tools typically used to machine dental prostheses may be prone to failure due to the increased stress of machining harder materials and this may be particularly troublesome when machining a bottom surface of a dental prosthesis.

### SUMMARY OF THE INVENTION

It has been recognized that it would be advantageous to develop a method for machining a dental prosthesis that reduces the likelihood of forming tool failure.

The invention provides a method of manufacturing a dental prosthesis, including obtaining a workpiece having a proximal end attached to a fixture and engaging the fixture with the machine tool. The workpiece is machined with a forming tool to form a bottom surface and at least a portion of a side surface of the dental prosthesis without machining a bottom cavity of the dental prosthesis. The workpiece is machined with the forming tool to form the bottom cavity of the dental prosthesis after forming the bottom surface and at least a portion of the side surface of the dental prosthesis. The forming tool follows a spiral tool path moving inward from an outer perimeter of the dental prosthesis. The machine tool and the workpiece are rotated relative to each other about a rotational axis of the fixture. The workpiece is machined with the forming tool to form a top and a portion of the side surface of the dental prosthesis.

In accordance with a more detailed aspect of the invention, the workpiece can be machined with the forming tool to form at least a portion of a connector between a proximal end of the dental prosthesis and the proximal end of the workpiece prior to forming the bottom cavity. The connector can have a strength sufficient to withstand a subsequent machining operation to form the dental prosthesis.

In accordance with another more detailed aspect of the invention, the portion of the side surface of the dental prosthesis can be machined prior to machining the bottom cavity. And the bottom cavity can be machined while the connector extends from the bottom of the dental prosthesis to a top of the workpiece.

In accordance with another more detailed aspect of the invention, the workpiece can be machined with the forming tool to form the bottom cavity of the dental prosthesis without using a sweep tool path with a plunging motion with the machining tool.

In accordance with another more detailed aspect of the invention, a plurality of workpieces can be obtained, each having a proximal end attached to the fixture.

In addition, the invention provides a method of manufacturing a dental prosthesis, including obtaining a ceramic workpiece having a proximal end attached to a fixture and engaging the fixture with the machine tool. The fixture has a rotational axis and the machine tool provides relative rotation about the rotational axis between the ceramic workpiece and the machine tool. The ceramic workpiece is machined with a forming tool to form a bottom and a portion of a side surface of the dental prosthesis. The forming tool follows a sweep tool path beginning at a distal end of the ceramic workpiece and moving generally toward the proximal end of the ceramic workpiece. The ceramic workpiece is machined with the forming tool to form a bottom and a side of a connector between a proximal end of the dental prosthesis and the proximal end of the ceramic workpiece. The ceramic workpiece is machined with the forming tool to form a bottom cavity of the dental prosthesis. The forming tool follows a spiral tool path moving inward from an outer perimeter of the dental prosthesis and downward from the bottom of the dental prosthesis. The connector has a strength sufficient to withstand a machining operation to form the bottom cavity of the dental prosthesis. The machine tool and the ceramic workpiece are rotated relative to each other about the rotational axis. The ceramic workpiece is machined with the forming tool to form a top and a portion of the side surface of the dental prosthesis. The forming tool follows a sweep tool path beginning at the distal end of the ceramic workpiece and moving generally toward the proximal end of the ceramic workpiece. A top of the connector is machined in the ceramic workpiece.

Furthermore, the invention provides a dental prosthesis precursor, including a ceramic workpiece having a proximal end attached to a fixture configured to engage with a machine tool, the fixture configured to have a rotational axis when engaged with the machine tool, a workpiece top and a workpiece bottom, the workpiece bottom having a bottom cavity of a dental prosthesis and the workpiece top having an unformed region where a top surface of the dental prosthesis can be formed, and a connector between a proximal end of the dental prosthesis and the proximal end of the ceramic workpiece, the connector having a strength sufficient to withstand a forming operation to form the top surface of the dental prosthesis.

### BRIEF DESCRIPTION OF THE DRAWINGS

Additional features and advantages of the invention will be apparent from the detailed description which follows, taken in conjunction with the accompanying drawings, which together illustrate, by way of example, features of the invention; and, wherein:

FIG. 1a is a bottom perspective view of a partially machined dental prosthesis workpiece in accordance with an embodiment of the present invention;

FIG. 1b is a bottom perspective view of a partially machined dental prosthesis workpiece in accordance with an embodiment of the present invention’

FIG. 2 is a perspective view of a machine tool and a dental prosthesis precursor in accordance with an embodiment of the present invention;

FIG. 3 is a depiction of a sweep tool path in accordance with an embodiment of the present invention;

FIG. 4 is a depiction of a spiral tool path in accordance with an embodiment of the present invention;

FIGS. 5a-8b are various views of a workpiece being machined into a dental prosthesis showing a method of manufacturing a dental prosthesis in accordance with the present invention, where:

FIGS. 5a and b are a bottom view and a side view, respectively, of the workpiece being machined to form a portion of a bottom, such as a bottom surface, and a portion of a side surface of the dental prosthesis;

FIGS. 6a and b are a bottom view and a side view, respectively, of the workpiece being machined to form a bottom cavity of the dental prosthesis;

FIGS. 7a and b are a bottom view and a side view, respectively, of the workpiece being machined to form the bottom cavity of the dental prosthesis; and

FIGS. 8a and b are a top view and a side view, respectively, of the workpiece being machined to form a top and a portion of the side surface of the dental prosthesis;

Reference will now be made to the exemplary embodiments illustrated, and specific language will be used herein to describe the same. It will nevertheless be understood that no limitation of the scope of the invention is thereby intended.

### DETAILED DESCRIPTION OF EXAMPLE EMBODIMENT(S)

The invention provides a method for cutting a dental prosthesis from a workpiece by machining a bottom of the dental prosthesis first, and then subsequently machining a top of the dental prosthesis. In addition, the method provides for first machining a bottom perimeter of the dental prosthesis, and then subsequently machining a bottom cavity of the dental prosthesis. A sweep path (e.g. back and forth from a distal to proximal end) is used to machine the bottom perimeter, and a spiral path (e.g. around from outer to inner and upper to lower) is used to machine the bottom cavity.

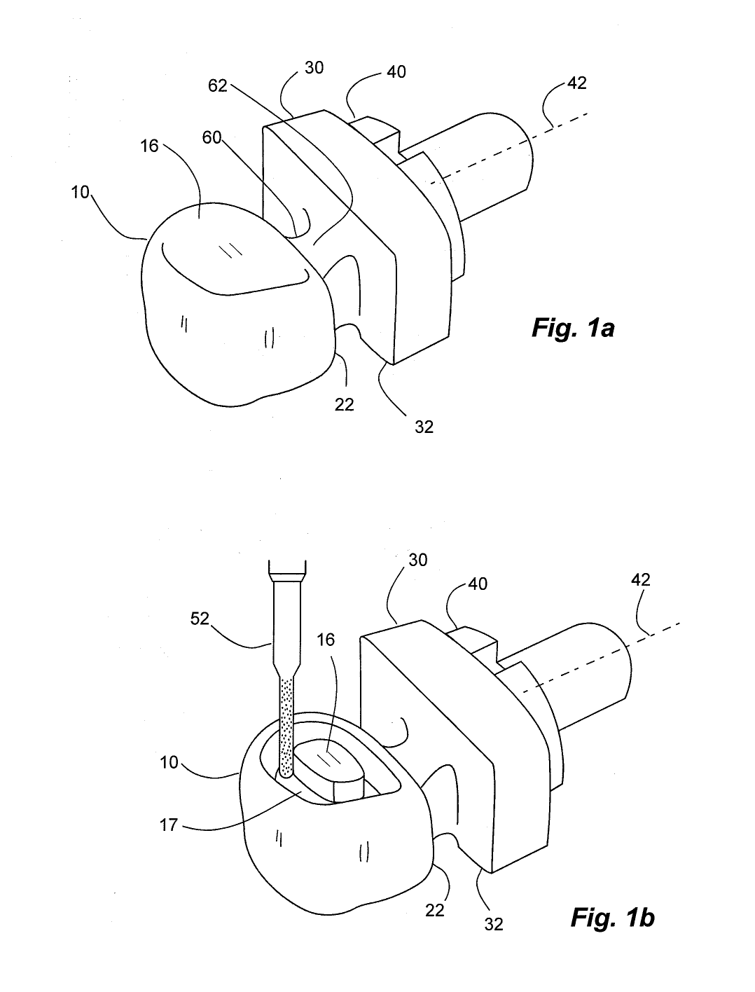

Illustrated in FIGS. 1a and 1b is a dental prosthesis 10 during manufacture in an example embodiment in accordance with the invention. In this embodiment, a workpiece 30 may be attached to a fixture 40. A connector 60 can be between a proximal end 22 of the dental prosthesis 10 and a proximal end 32 of the workpiece 30. Also illustrated is that the dental prosthesis 10 may be formed by a forming or machining tool 52. A workpiece 30 may comprise any suitable dental prosthesis material, for example, machinable ceramics such as glass ceramics (i.e. feldspar ceramic and lithium disilicate ceramic) and partially sintered ceramics (i.e. zirconium oxid and aluminium oxid).

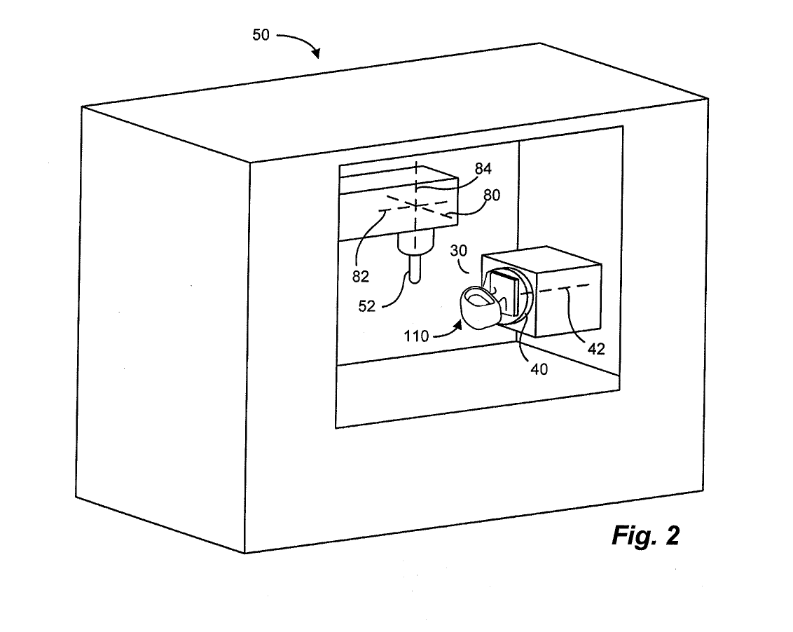

As illustrated in FIG. 2, a dental prosthesis 10 may be formed using a machine tool 50. A machine tool 50 may provide linear movement in at least three axes 80, 82, 84 and rotational movement about at least one axis 42. For example, a machine tool 50 may provide linear movement in X, Y, and Z orthogonal axes. In one aspect of this embodiment, a machine tool 50 may provide rotation about any one of the X, Y, or Z axes. Such a machine tool is known as a 4-axis machine. In another aspect of this embodiment, a machine tool 50 may provide rotation about any two of the X, Y, and Z axes. Such a machine tool is known as a 5-axis machine. In the embodiment depicted in FIGS. 1a and 1b, the X-axis may be axis 80, the Y-axis may be axis 82, and the Z-axis may be axis 84. Rotation is about axis 42, which is parallel to axis 82 or the Y-axis. Thus, this embodiment is a 4-axis machine with rotation about the Y-axis.

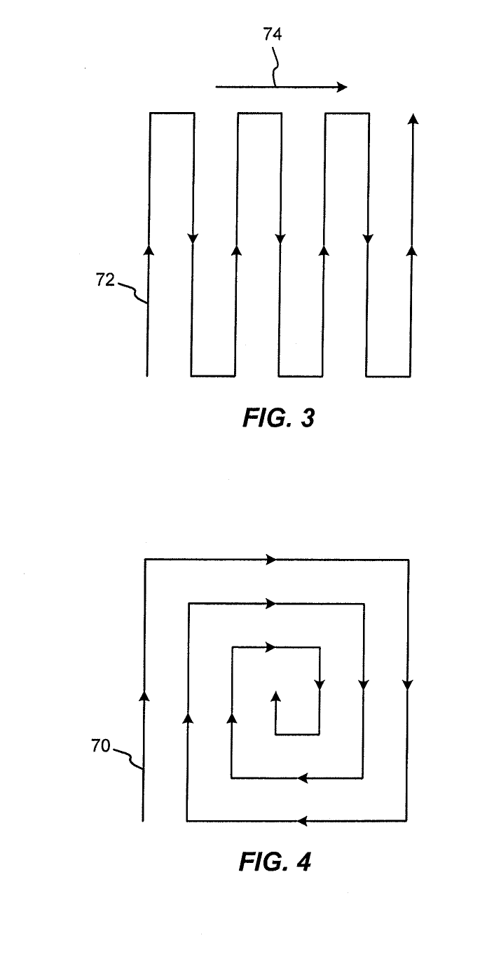

A machine tool 50 may have movement controlled by a computer, such as in computer numerical controlled (CNC) machining. A machine tool 50 may be programmed to machine a part by utilizing a sequence of machine tool movements that control a forming tool. A sequence of machine tool movements may be known as a tool path. FIGS. 3 and 4 depict two exemplary embodiments of tool path types. FIG. 3 illustrates a sweep tool path 72. A sweep tool path 72 may have side-to-side movement shown by the arrows on sweep tool path 72. Arrow 74 illustrates a direction of movement generally of the sweep tool path 72.

FIG. 4 illustrates a spiral tool path 70. A spiral tool path 70 may spiral inward from an outer perimeter as illustrated in FIG. 4. On the other hand, a spiral tool path may spiral outward from a center point (not shown). A spiral tool path may be square shaped, circle shaped, or any other shape that allows a spiral path, either inward or outward. For example, a contour line of a complex contoured surface may provide a spiral tool path shape 71 (FIGS. 6a and 7a). In one embodiment, a spiral tool path may follow one contour line about a perimeter and move to successively more inward contour lines as the spiral continues.

In another embodiment, a spiral tool path may be governed by a scallop height and/or gouge detection of a tool with a part. For example, a scallop height may be the height of material left between two adjacent tool passes at a given location. Scallop height may be reduced by making adjacent tool passes closer together. Gouge detection may prevent a tool from removing material below a part surface. In some cases if a forming tool is too large, gouge detection may result in a tool path that prevents a certain portion of a part surface from being machined. For example, a small concave region may not be machined by a tool that is too large to fit in the region. Thus, scallop height requirements and/or gouge detection may be used to define successive adjacent tool passes that make up a spiral too path. Computer aided design and/or computer aided manufacturing (CAD/CAM) systems may be used to design tool paths with a predetermined scallop height and/or with gouge detection.

Any tool path, sweep or spiral, may be generated that causes the forming tool to machine a part surface in a single tool pass. Alternatively, a series of “roughing” tool passes may be used to remove material from a workpiece before the final part surface is machined.

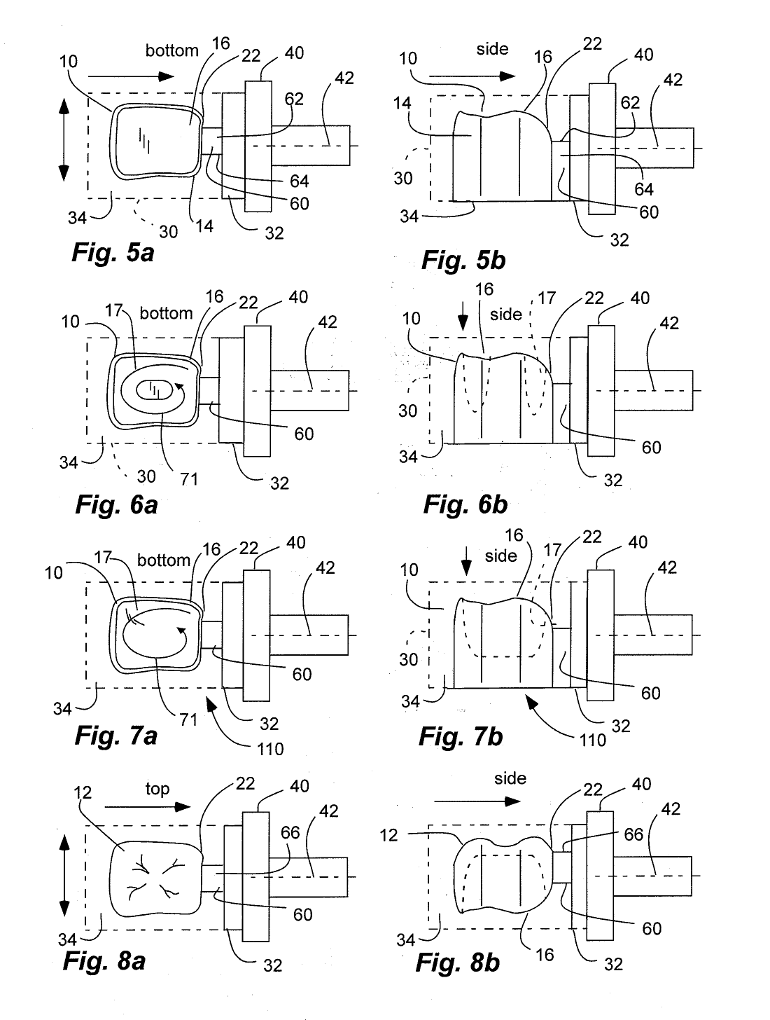

With reference to FIGS. 5a-8b, and continued reference to FIGS. 1a-4, a method for forming the dental prosthesis 10 will be discussed. Referring to FIGS. 5a and 5b, a method for forming the dental prosthesis 10 may include obtaining a workpiece 30 having a proximal end 22 attached to a fixture 40. A fixture 40 may be configured to engage with a machine tool. For example, a fixture may have an extension configured to engage with a machine tool such as a cylinder shaped extension as shown. Once a workpiece attached to a fixture is obtained, the fixture 40 may be engaged with the machine tool (shown in FIG. 2 but not shown in FIGS. 5a-8b). A machine tool may engage a fixture 40 with a collet, chuck, clamp, or any other means of securing a workpiece or fixture known in the machine tool art.

The fixture 40 may have a rotational axis 42. When the fixture 40 is engaged with the machine tool, the machine tool may provide relative rotation about the rotational axis 42 between the workpiece 30 and the machine tool. In one embodiment, rotating the machine tool and the workpiece 30 relative to each other may comprise causing the fixture 40 to rotate about the rotational axis 42. In other words, a machine tool may provide relative rotation by rotating the workpiece 30 via its attachment to the fixture and the machine tool and holding the forming tool 52 in a fixed position. In another embodiment, rotating the machine tool and the workpiece 30 relative to each other may comprise rotating the forming tool 52 about the rotational axis 42. In other words, a machine tool may provide relative rotation by rotating the forming tool 52 about the rotational axis 42 and holding the workpiece 30 in a fixed position. In yet another embodiment, relative rotation may be achieved by some combination of rotating the forming tool 52 and the workpiece 30 about the rotational axis 42. The amount of relative rotation may vary and may be any amount depending on the characteristics of the machine tool and the dental prosthesis to be machined. In one embodiment, rotating the machine tool and the workpiece 30 relative to each other may comprise a relative rotation of about 180 degrees about the rotational axis 42.

In addition, a plurality of workpieces can be coupled to a single fixture or jig. Thus, the rotational axis need not correspond to one or all of the workpieces.

Referring to FIGS. 5a and 5b, a method for forming the dental prosthesis 10 can include machining the workpiece 30 with a forming tool 52 to form at least a portion of a side surface 14 and/or a bottom surface 16, or a portion thereof, of the dental prosthesis 10. For example, the workpiece 30 can be machined to form a perimeter outline of the dental prosthesis and a taper or radius between the perimeter and the bottom, as shown in FIGS. 5a and 5b.

In one aspect, when machining the workpiece 30 to form the side surface 14, the perimeter, and/or the bottom surface 16, the forming tool 52 may follow a sweep tool path beginning at a distal end 34 of the workpiece 30 and move generally toward the proximal end 32 of the workpiece 30. In another aspect, when machining the workpiece 30 to form the bottom surface 16, the side surface 14, and/or perimeter, the forming tool 52 may follow a spiral tool path beginning at an outer perimeter of the dental prosthesis 10 and moving inward. In yet another aspect, when machining the workpiece 30 to form the bottom surface 16, the side surface 14, and/or perimeter, the forming tool 52 may follow a spiral tool path beginning at a center point of the dental prosthesis 10 and moving outward. In still another aspect, when machining the workpiece 30 to form the bottom surface 16, the side surface 14, and/or the perimeter, the forming tool 52 may follow a combination of a sweep tool path and a spiral tool path. In other words, machining the bottom surface 16 and the side surface 14 of a dental prosthesis may comprise machining all surfaces of a dental prosthesis 10 in a sweep, spiral, or combination tool path that are accessible by a forming tool from a bottom side of the workpiece 30 (a side corresponding to a bottom side of the dental prosthesis 10).

In one aspect, machining the bottom surface 16 can include leaving the material or the workpiece associated with the bottom cavity of the dental prosthesis. Thus, machining the bottom surface and/or side surface of the dental prosthesis can be done without machining the bottom cavity.

In one aspect, a forming tool 52 can comprise an abrasive for removing material. In one aspect, the abrasive can comprise diamond, such as a diamond bur. In another aspect, a forming tool 52 can comprise an end mill, such as a ball end mill, a filleted end mill, or a flat end mill. A forming tool, whether comprising an abrasive or cutting edges as in an end mill, can have a ball end, filleted end, or flat end.

In addition, a method for forming the dental prosthesis 10 can include machining the workpiece 30 with the forming tool 52 to form at least a portion of a connector 60 between a proximal end 22 of the dental prosthesis 10 and the proximal end 32 of the workpiece 30. In one aspect, the forming tool 52 may form a bottom 62 and sides 64 of the connector 60. In addition, the connector 60 can extend from the bottom of the dental prosthesis to a top of the workpiece (particularly while the bottom cavity is machined), as shown in FIGS. 5b and 6b. Thus, at this point, the top of the connector and the top of the workpiece can be flush or co-planar. In one aspect, the connector 60 may be formed by machining in a sweep tool path. In another aspect, the connector 60 may be formed by machining in a spiral tool path. In yet another aspect, the connector 60 may be formed by a combination of a sweep tool path and a spiral tool path. The connector 60 may have a strength sufficient to withstand a subsequent machining operation to form the connector 60 or the dental prosthesis 10. For example, in one embodiment, a connector can be formed prior to forming the bottom cavity of the dental prosthesis 10. In this case, it is desirable that the connector be strong enough to withstand machining forces during machining the bottom cavity of the dental prosthesis 10.

Referring to FIGS. 6a-7b, a method for forming the dental prosthesis 10 can include machining the workpiece with the forming tool to form the bottom cavity 17 or concave recess of the dental prosthesis. The bottom cavity 17 can be formed after forming the bottom surface 16 and the side surface 14 of the dental prosthesis. The forming tool can follow a spiral tool path 71 moving inward from an outer perimeter of the dental prosthesis. In one aspect, a tool path for machining the bottom cavity 17 of the dental prosthesis 10, the forming tool 52 may follow a spiral tool path. In one aspect, the forming tool 52 may move inward from an outer perimeter of the dental prosthesis 10 and downward from the bottom surface. A bottom surface 16 of a dental prosthesis 10 having a relatively deep concave recess may be difficult to machine without breaking the forming tool 52. A spiral tool path moving inward from an outer perimeter may help to preserve the forming tool 52 because the forming tool 52 may not be subjected to the full depth of the concave region initially, but may be introduced to it gradually. This may reduce the load on the forming tool 52 while machining the concave region. Referring to FIGS. 6a and 6b, a center stem can be initially formed in the bottom cavity as the bottom cavity is machined, but subsequently removed, as shown in FIGS. 7a and 7b. The bottom cavity of the dental prosthesis can be machined without using sweep tool path with a plunging motion of the forming tool.

A method for forming the dental prosthesis 10 may further include rotating the machine tool and the workpiece 30 relative to each other about a rotational axis 42 of the fixture 40. In one aspect, rotating the machine tool and the workpiece 30 relative to each other may comprise causing the fixture 40 to rotate about the rotational axis 42. In another aspect, rotating the machine tool and the workpiece 30 relative to each other may comprise rotating the forming tool 52 about the rotational axis 42. In one aspect, the relative rotation may be about 180 degrees.

Referring to FIGS. 8a and 8b, a method for forming the dental prosthesis 10 can include machining the workpiece 30 with the forming tool 52 to form a top surface 12, and at least a portion of a side surface 14 of the dental prosthesis 10. In one aspect, when machining the workpiece 30 to form the top surface 12 and at least a potion of the side surface 14, the forming tool 52 may follow a sweep tool path beginning at a distal end 34 of the workpiece 30 and move generally toward the proximal end 32 of the workpiece 30. In another aspect, when machining the workpiece 30 to form the top surface 12 and at least a potion of the side surface 14, the forming tool 52 may follow a spiral tool path beginning at an outer perimeter of the dental prosthesis 10 and moving inward. In yet another aspect, when machining the workpiece 30 to form the top surface 12 and at least a potion of the side surface 14, the forming tool 52 may follow a spiral tool path beginning at a center point of the dental prosthesis 10 and moving outward. In still another embodiment, when machining the workpiece 30 to form the top surface 12 and at least a potion of the side surface 14, the forming tool 52 may follow a combination of a sweep tool path and a spiral tool path. In other words, machining the top surface 12 and the side surface 14 of a dental prosthesis may comprise machining all surfaces of a dental prosthesis 10 in a sweep, spiral, or combination tool path that are accessible by a forming tool from a top side of the workpiece 30 (a side corresponding to a top side of the dental prosthesis 10).

The connector 60 may be sized to minimize an unmachined area on a side surface 14 at the proximal end 22 of the dental prosthesis 10. In one embodiment, the connector 60 may be sized such that it is smaller in cross-section than the outer boundary of the dental prosthesis 10. In another embodiment, the connector 60 may have a variable cross-section along its length. In this embodiment, the connector 60 may be larger near the proximal end 32 of the workpiece 30 and smaller near the proximal end 22 of the dental prosthesis 10.

A method for forming the dental prosthesis 10 may include additional machining of the connector 60, for example, machining a top 66 and/or bottom of the connector 60 in the workpiece 30. As discussed above, the connector may have a strength sufficient to withstand additional machining operations, such as a machining operation to form the bottom cavity 17, the top surface 12, and/or the side surface 14 of the dental prosthesis 10. In one aspect, the top 66 of the connector 60 may be formed by machining in a sweep tool path. In another aspect, the connector 60 may be formed by machining in a spiral tool path. In yet another aspect, the connector 60 may be formed by a combination of a sweep tool path and a spiral tool path.

With further reference to FIGS. 2, 7a and 7b, a dental prosthesis precursor 110 is described. In one embodiment, a dental prosthesis precursor 110 may comprise a workpiece 30 having a proximal end 32 attached to a fixture 40 configured to engage with a machine tool. The fixture 40 may be configured to have a rotational axis 42 when engaged with the machine tool. In one aspect of this embodiment, the workpiece 30 may have a workpiece top and a workpiece bottom. The workpiece bottom may have the form of a bottom surface 16 of a dental prosthesis 10 with a bottom cavity 17, and the workpiece top may have an unformed region where a top surface of the dental prosthetic can be formed. In another aspect of this embodiment, a connector may be between a proximal end 22 of the dental prosthesis 10 and the proximal end 32 of the ceramic workpiece 30. The connector 60 may have a strength sufficient to withstand a forming operation to form the top surface of the dental prosthesis 10. A dental prosthesis precursor 110 may be formed by any suitable manufacturing process, such as forms of machining, casting, molding, grinding, electrical discharge machining (EDM), fused deposition modeling (FDM), etc.

With further reference to FIG. 2, a dental prosthesis manufacturing system is described. In one embodiment, a dental prosthesis manufacturing system may comprise a dental prosthesis precursor 110 and a machine tool 50, as discussed above. In one aspect of this embodiment, the machine tool 50 may comprise a forming tool 52. In another aspect of this embodiment, the machine tool 50 may be configured to rotate the fixture 40 about the rotational axis 42. In yet another aspect of this embodiment, the machine tool 50 may be configured to rotate a forming tool 52 about the rotational axis 42. In still another aspect of this embodiment, the forming tool 52 may comprise an abrasive for removing material. In even another aspect of this embodiment, the abrasive may comprise a diamond bur. A diamond bur may comprise diamond, diamond embedded in a bur, or diamond coating over a bur. In a further aspect of this embodiment, the forming tool 52 may comprise an end mill. In yet a further aspect of this embodiment, the dental prosthesis precursor 110 may be engaged with the machine tool 50.

While the forgoing examples are illustrative of the principles of the present invention in one or more particular applications, it will be apparent to those of ordinary skill in the art that numerous modifications in form, usage and details of implementation can be made without the exercise of inventive faculty, and without departing from the principles and concepts of the invention. Accordingly, it is not intended that the invention be limited, except as by the claims set forth below.

1. A method of manufacturing a dental prosthesis, comprising:
obtaining a workpiece having a proximal end attached to a fixture and engaging the fixture with the machine tool;
machining the workpiece with a forming tool to form a bottom surface and at least a portion of a side surface of the dental prosthesis without machining a bottom cavity of the dental prosthesis;
machining the workpiece with the forming tool to form the bottom cavity of the dental prosthesis after forming the bottom surface and at least a portion of the side surface of the dental prosthesis, the forming tool following a spiral tool path moving inward from an outer perimeter of the dental prosthesis;
rotating the machine tool and the workpiece relative to each other about a rotational axis of the fixture; and
machining the workpiece with the forming tool to form a top and a portion of the side surface of the dental prosthesis.

2. The method of claim 1, further comprising:
machining the workpiece with the forming tool to form at least a portion of a connector between a proximal end of the dental prosthesis and the proximal end of the workpiece prior to forming the bottom cavity, the connector having a strength sufficient to withstand a subsequent machining operation to form the dental prosthesis.

3. The method of claim 2, wherein the portion of the side surface of the dental prosthesis is machined prior to machining the bottom cavity, and wherein the bottom cavity is machined while the connector extends from the bottom of the dental prosthesis to a top of the workpiece.

4. The method of claim 1, wherein machining the workpiece with the forming tool to form the bottom cavity of the dental prosthesis further includes machining the workpiece to form the bottom cavity of the dental prosthesis with a spiral tool path without using sweep tool path with a plunging motion with the machining tool.

5. The method of claim 1, wherein machining the workpiece with the forming tool to form the bottom surface and the at least the portion of the side surface of the dental prosthesis comprises a first tool path that is a sweep tool path; and wherein machining the workpiece with the forming tool to form the bottom cavity of the dental prosthesis comprises a second tool pass that is the spiral tool path.

6. The method of claim 1, wherein machining the workpiece with the forming tool to form the bottom cavity of the dental prosthesis comprises a roughing tool pass and a finishing tool pass, the roughing tool pass having the forming tool following the spiral tool path.

7. The method of claim 1, wherein obtaining the workpiece further includes obtaining a plurality of workpieces, each having a proximal end attached to the fixture.

8. A method of manufacturing a dental prosthesis, comprising:
obtaining a ceramic workpiece having a proximal end attached to a fixture and engaging the fixture with the machine tool, said fixture having a rotational axis and said machine tool providing relative rotation about the rotational axis between the ceramic workpiece and the machine tool;
machining the ceramic workpiece with a forming tool to form a bottom and a portion of a side surface of the dental prosthesis, the forming tool following a sweep tool path beginning at a distal end of the ceramic workpiece and moving generally toward the proximal end of the ceramic workpiece;
machining the ceramic workpiece with the forming tool to form a bottom and a side of a connector between a proximal end of the dental prosthesis and the proximal end of the ceramic workpiece;
machining the ceramic workpiece with the forming tool to form a bottom cavity of the dental prosthesis, the forming tool following a spiral tool path moving inward from an outer perimeter of the dental prosthesis and downward from the bottom of the dental prosthesis, the connector having a strength sufficient to withstand a machining operation to form the bottom cavity of the dental prosthesis;
rotating the machine tool and the ceramic workpiece relative to each other about the rotational axis;
machining the ceramic workpiece with the forming tool to form a top and a portion of the side surface of the dental prosthesis, the forming tool following a sweep tool path beginning at the distal end of the ceramic workpiece and moving generally toward the proximal end of the ceramic workpiece; and
machining a top of the connector in the ceramic workpiece.

9. The method of claim 8, wherein machining the ceramic workpiece with the forming tool to form the bottom and the portion of the side surface of the dental prosthesis further includes machining the ceramic workpiece from a bottom of the dental prosthesis without machining the bottom cavity of the dental prosthesis.

10. The method of claim 8, wherein machining the ceramic workpiece with the forming tool to form the bottom cavity of the dental prosthesis further includes machining the ceramic workpiece to form the bottom cavity of the dental prosthesis without using sweep tool path with a plunging motion with the machining tool.

11. The method of claim 8, wherein the portion of the side surface of the dental prosthesis is machined prior to machining the bottom cavity, and wherein the bottom cavity is machined while the connector extends from the bottom of the dental prosthesis to a top of the ceramic workpiece.

12. The method of claim 8, wherein the top of the connector is formed by machining in a sweep tool path.

13. The method of claim 8, wherein the bottom of the connector is formed by machining in a sweep tool path.

14. A dental prosthesis precursor, comprising:
a ceramic workpiece having
a proximal end attached to a fixture configured to engage with a machine tool, the fixture configured to have a rotational axis when engaged with the machine tool,
a workpiece top and a workpiece bottom, the workpiece bottom having a bottom cavity of a dental prosthesis and the workpiece top having an unformed region where a top surface of the dental prosthesis can be formed, and
a connector between a proximal end of the dental prosthesis and the proximal end of the ceramic workpiece, the connector having a strength sufficient to withstand a forming operation to form the top surface of the dental prosthesis.

15. A dental prosthesis manufacturing system, comprising:
a dental prosthesis precursor as in claim 14; and
a machine tool.

16. The system of claim 15, wherein the machine tool is configured to rotate the fixture about the rotational axis.

17. The system of claim 15, wherein the machine tool is configured to rotate a forming tool about the rotational axis.

18. The system of claim 15, wherein the machine tool comprises a forming tool.

19. The system of claim 18, wherein the forming tool comprises an abrasive diamond bur.

20. The system of claim 15, wherein the dental prosthesis precursor is engaged with the machine tool.
